(19) United States
(12) Patent Application Publication
(10) Pub. No.: US 2016/0064125 A1
(43) Pub. Date: Mar. 3, 2016

(54) POWDER METALLURGICAL METHOD FOR FABRICATING HIGH-DENSITY SOFT MAGNETIC METALLIC MATERIAL

(71) Applicant: TAIWAN POWDER TECHNOLOGIES CO., LTD., Taoyuan County (TW)

(72) Inventors: Kuen-Shyang HWANG, Taipei (TW); Yung-Chung LU, Taoyuan County (TW); Yang-Liang FAN, Taoyuan County (TW); Wei-Chen TSENG, Taoyuan County (TW)

(21) Appl. No.: 14/474,990

(22) Filed: Sep. 2, 2014

(51) Int. Cl. H01F 1/22; B22F 3/12; H01F 41/02

(52) U.S. Cl. CPC H01F 1/22; H01F 41/02; B22F 3/12

(57) ABSTRACT

A powder metallurgical method for fabricating a high-density soft magnetic metallic material comprises steps of providing an initial powder; using a spray drying process to fabricate the initial powder into a spray-dried powder; placing the spray-dried powder in a mold and compacting the spray-dried powder under a compacting pressure and a compacting temperature to form a green compact; and sintering the green compact at a sintering temperature to form a soft magnetic metallic material. The spray-dried powder, which is fabricated by the spray drying process, has superior flowability, compactability and compressibility and is suitable for the press-and-sinter process. The soft magnetic metallic material fabricated by the present invention is outstanding in sintered density and magnetic performance. The present invention adopts the inexpensive press-and-sinter process and has a low fabrication cost.

### FIELD OF THE INVENTION

The present invention relates to a method for fabricating a soft magnetic metallic material, particularly to a press-and-sinter method for fabricating a high-density soft magnetic metallic material.

### BACKGROUND OF THE INVENTION

Soft magnetic metallic materials feature high induced magnetism (Bₛ) and low coercive force (H_{c}), widely used in electronic and electromagnetic industries. Ordinary soft metallic materials are often fabricated using a conventional press-and-sinter process: firstly, the alloy powders having the required components are mixed with a lubricant to form a uniform mixture; next, the mixture is filled into a mold and compressed at ambient temperature with required pressure to form a green compact having a given density and strength; next, the green compact is heated to remove the lubricant and then sinter the green compact into the desired soft magnetic metallic material. The press-and-sinter process has advantages of low material cost, low mold cost and low fabrication cost.

In order to achieve superior mechanical and physical properties, the sintered soft magnetic metallic material should have a density as high as possible, meaning that the un-sintered compact (i.e. the green compact) should have a density as high as possible also. The high-density green compact also provides a smaller amount of dimensional shrinkage than that of a low-density green compact. Therefore, high green compact density results in high dimensional stability.

Particles with small diameters have large surface area and thus have high driving force for sintering. Therefore, in addition to high compaction pressure and high green compact density, the use of fine powders is necessary for achieving a high-density product. However, fine particles have a large number of contact points, which results in high friction, low compressibility and poor compactability. Therefore, fine powders need a higher compaction pressure to acquire the desired green compact density. However, too high a compaction pressure may cause the green compact to spring back seriously and delaminate when the green compact is ejected out of the mold. Besides, high compaction pressure wears the mold faster. Further, the equipment with a high compaction pressure is more expensive. Moreover, fine powders are poor in flowability and thus difficult to fill into the mold cavity and cause problems in automation, which would increase the fabrication cost further.

On the other hand, if coarse powders are used, there are other problems occurring. For example, the current technology uses a mixture of iron powders having a large particle diameter of about 70 μm and iron phosphide (Fe₃P) powders having a small particle diameter of about 5 μm to fabricate Fe-0.45% P soft magnetic metallic materials. The mixed powder has good flowability and high apparent density and thus is suitable for the conventional press-and-sinter process. The mixed powder has a green compact density of 6.4-7.1 g/cm³. According to Metal Powder Industry Federation Standard 35 (MPIF Standard 35), the sintered product of such a green compact made of the mixed powder has a density of only 6.8-7.4 g/cm³, however. Therefore, the conventional press-and-sinter process is unlikely to fabricate the abovementioned mixed powder into a high-density sintered product because the particle size is too large.

In addition to the conventional press-and-sinter process, conventional Metal Injection Molding (MIM) process has also been used to fabricate powder metallurgical products. The MIM process fabricates green compacts in an injection molding way and thus can adopt fine metal particles. The MIM process is less likely to be influenced by the flowability and apparent density of the powder. For example, when the MIM process is used to fabricate a Fe-3% Si soft magnetic metallic material, it normally adopts mixture of iron powders and Fe—Si pre-alloyed powders both having small particle diameters. The mixture is mixed with about 30-40 vol % of a binding agent and then injected into a mold using an injection molding machine to form green compacts having a density of 4.5-5.5 g/cm³. The green compacts are debinded to remove the binder. Then, the green compacts are sintered at a high temperature to form high-density products. According to the MPIF Standard 35, the Fe-3% Si product fabricated by the MIM process has a sintered density of about 7.5 g/cm³ and has fine magnetic performance. The MIM process can fabricate soft magnetic metallic materials meeting requirements. Further, the MIM process outperforms the conventional press-and-sinter process in sintered density and magnetic performance. However, the MIM process cost is about 10 times that of the press-and-sinter process. Because the green compact of the MIM process has low density and the product thereof has high density, the sintered product has considerable amount of linear shrinkage, normally higher than 12%. Thus, the dimensional variation is hard to control in the MIM process.

In conclusion, the conventional press-and-sinter process neither achieves high sintered density nor obtains fine magnetic performance; the conventional MIM process is expensive and has difficulties in dimensional control.

### SUMMARY OF THE INVENTION

The primary objective of the present invention is to overcome the problems of insufficient sintered density and poor magnetic performance of the soft magnetic metallic materials fabricated by the conventional press-and-sinter process, and the problems of expensiveness and poor dimensional control of the soft magnetic metallic materials fabricated by the conventional MIM process.

To achieve the abovementioned objective, the present invention proposes a powder metallurgical method for fabricating a high-density soft magnetic metallic material, which comprises

Step S1: providing an initial powder including iron and featuring soft magnetism, wherein the initial powder has a median particle diameter of 1-15 μm, wherein the iron is sourced from a carbonyl iron powder;

Step S2: using a spray drying process to fabricate the initial powder into a spray-dried powder, wherein the spray-dried powder is formed to a spherical shape or a near-spheroidal shape with a median diameter of 40-100 μm and having good flowability;

Step S3: placing the spray-dried powder in a mold, maintaining the spray-dried powder at a temperature of 20-150° C., and compacting the spray-dried powder under a pressure of 300-1000 MPa to form a green compact; and

Step S4: sintering the green compact at a temperature of 1100-1400° C. in a protection atmosphere to form a soft magnetic metallic material.

The present invention further proposes another powder metallurgical method for fabricating a high-density soft magnetic metallic material, which comprises

Step S1: providing an initial powder including iron and featuring soft magnetism, wherein the initial powder has a median particle diameter of 1-15 μm and is a pre-alloyed powder;

Step S2: using a spray drying process to fabricate the initial powder into a spray-dried powder, wherein the spray-dried powder is formed to a spherical shape or a near-spheroidal shape with a median diameter of 40-100 μm and having good flowability;

Step S3: placing the spray-dried powder in a mold, maintaining the spray-dried powder at a temperature of 20-150° C., and compacting the spray-dried powder under a pressure of 300-1000 MPa to form a green compact; and

Step S4: sintering the green compact at a temperature of 1100-1400° C. in a protection atmosphere to form a soft magnetic metallic material.

The present invention is characterized in using the spray drying process to obtain the spray-dried powder. The spray-dried powder has a spherical shape and thus has superior flowability, compactability and compressibility. In comparison with the powder not processed by the spray drying method, the spray-dried powder can be fabricated into a high-density green compact with an automated pressing process. Thus, the soft magnetic metallic materials fabricated with the spray-dried powder outperform the soft magnetic metallic materials fabricated with coarse powder and the conventional press-and-sinter process, in the relative density and the magnetic performance. The products made from spray-dried powder and fabricated with the press-and-sinter process are less expensive than the products fabricated with the MIM process. Further, the green compact made of the spray-dried powder and fabricated with the press-and-sinter process has higher density than the green compact fabricated with the MIM process. Therefore, the present invention characterized in using spray-dried powder has a small amount of shrinkage and is thus easy to control the dimensions.

### BRIEF DESCRIPTION OF THE DRAWINGS

FIG. 1 is a flowchart of a powder metallurgical method for fabricating a high-density soft magnetic metallic material according to one embodiment of the present invention.

### DETAILED DESCRIPTION OF THE PREFERRED EMBODIMENTS

Below, the technical contents of the present invention are described in detail in cooperation with the drawings.

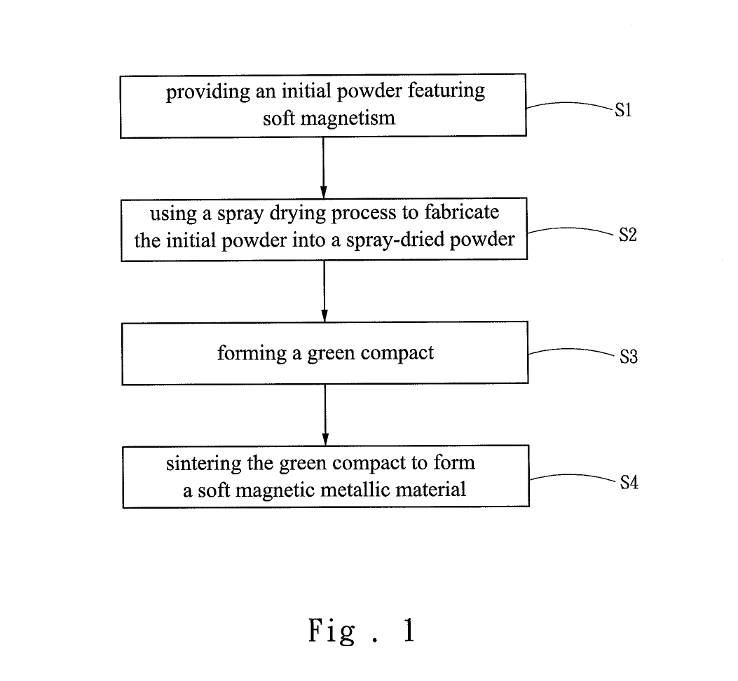

Refer to FIG. 1 a flowchart of a powder metallurgical method for fabricating a high-density soft magnetic metallic material according to one embodiment of the present invention.

In Step S1, provide an initial powder including iron and featuring soft magnetism. It is preferred: the initial powder has a median particle diameter of less than 15 μm. In some embodiments, the initial powder is a carbonyl iron powder including less than 0.05 wt % of carbon. In some embodiments, the initial powder is a pre-alloyed powder, a compound powder, a master alloy powder, or a mixture thereof. In some embodiments, the initial powder includes iron and at least one additive element selected from a group consisting of phosphorus, silicon, cobalt, vanadium, nickel, molybdenum and combinations thereof For example, the initial powder is a powder including soft magnetic metals, such as a mixture of an iron powder and a iron-phosphide powder (a Fe₃P powder), a mixture of an iron powder and a silicon powder (a Fe—Si master alloy powder), a mixture of iron powder and a cobalt powder (a Fe—Co mixed powder), a mixture of an iron powder, a cobalt powder, and a vanadium powder (an Fe—Co—V mixed powder), a mixture of iron powder and nickel powder (an Fe—-Ni mixture powder), a mixture of an iron powder, a nickel powder and a molybdenum powder (an Fe—Ni—Mo mixed powder), or a pre-alloyed powder including some of the abovementioned elements.

In some embodiments, the initial powder includes 0.4-0.9 wt % of phosphorus with the balance being iron and unavoidable impurities. In some embodiments, the initial powder includes 2-6 wt % of silicon with the balance being iron and unavoidable impurities. In some embodiments, the initial powder includes 48-52 wt % of cobalt and less than 3 wt % of vanadium, with the balance being iron and unavoidable impurities. In some embodiments, the initial powder includes 48-52 wt % of nickel with the balance being iron and unavoidable impurities. In some embodiments, the initial powder includes 77-83 wt % of nickel and less than 5 wt % of molybdenum, with the balance being iron and unavoidable impurities.

In Step S2, use a spray drying process to fabricate the initial powder into a spray-dried powder. In some embodiments, the spray-dried powder has a spherical shape or a near-spheroidal shape with a median diameter of 40-100 μm. In some embodiments, water and a binding agent are added to the initial powder to form a mixture; the binding agent is selected from a group consisting of Arabic gum, methyl cellulose, polyvinyl alcohol, polyethylene glycol and a mixture thereof. The spherical shape and the 40-100 μm median diameter will improve the flowability, compressibility, apparent density and compactability of the spray-dried powder.

In Step S3, place the spray-dried powder in a mold, maintain the spray-dried powder at a compacting temperature of 20-150° C., and compact the spray-dried powder under a compacting pressure of 300-1000 MPa to form a green compact. However, the present invention does not limit that the compacting temperature and the compacting pressure must be within the abovementioned ranges. In some embodiments, a lubricant is added to the spray-dried powder before the spray-dried powder is placed in a mold; the lubricant is selected from a group consisting of Acrawax®, stearic acid, zinc stearate, and other lubricants. In some embodiments, the mold includes a die, an upper punch and a lower punch; the die and the upper punch are heated; heat is transferred to the spray-dried powder via thermal conduction to maintain the spray-dried powder at a temperature of 20-150° C.; alternatively, the feed shoe and transport pipe of the spray-dried powder are heated in an electric heating way or an oil heating way to maintain the spray-dried powder at a temperature of 20-150° C.

In Step S4, undertake a debinding process, wherein the green compact is heated to a debinding temperature to remove the lubricant or the binding agent; then raise the temperature to a sintering temperature to obtain a soft magnetic metallic material; alternatively, debind the green compact in a chemical method, and then raise the temperature to a sintering temperature to obtain a soft magnetic metallic material. In some embodiments, Step S4 is undertaken in a vacuum furnace or an atmosphere furnace; if Step S4 is undertaken in an atmosphere furnace, the atmosphere should include hydrogen or cracked ammonia, and the sintering temperature ranges from 1100 to 1400° C. The soft magnetic metallic material obtained in Step S4 would have a relative density higher than 94%.

Below, embodiments are used to further demonstrate the powder metallurgical method for fabricating a high-density soft magnetic metallic material of the present invention. Besides, fabrications using other technologies are used as comparisons of the embodiments.

### Embodiment I

In Embodiment I, the initial powder is a Fe-50Co mixed powder. In detail, the Fe-50Co mixed powder is a mixture of a carbonyl iron powder and a cobalt powder; the Fe-50Co mixture powder includes 50 wt % of cobalt with the balance being iron; the carbonyl iron powder includes less than 0.05 wt % of carbon so as to increase the compressibility and the green compact density. In Embodiment I, both the carbonyl iron powder and the cobalt powder have a median particle diameter of less than 10 μm. The particles of the carbonyl iron powder and the cobalt powder are too fine to measure the flowability and apparent density thereof according to the MPIF standards. Before the spray drying process is undertaken, the Fe-50Co mixed powder is mixed with water and a binding agent. The binding agent includes polyvinyl alcohol and polyethylene glycol whose total additive amount is 1.0 wt % of the metal powder. The spray drying process fabricates the initial powder into a spray-dried powder, whose particles are spherical with a median diameter of 75 μm. The spray-dried powder has appropriate flowability of 30 sec/50 g according to MPIF Standard 03 and has an apparent density of 2.1 g/cm³ according to MPIF Standard 04. Next, the spray-dried powder is mixed with a lubricant—Acrawax®. The amount of the Acrawax® is 0.1 wt %. Next, the spray-dried powder is placed in a mold, maintained at a temperature of 35° C., and compacted under a pressure of 600 MPa to form a green compact having a density of 6.2 g/cm³. Next, the green compact is placed in a reducing cracked-ammonia atmosphere furnace filled with 75 vol % of hydrogen and 25 vol % of nitrogen, held at a temperature of 300-600° C. to remove the binding agent and the lubricant, and then sintered at a temperature of 1355° C. for 2 hours to obtain a Fe-50Co soft magnetic metallic material. The Fe-50Co soft magnetic metallic material has a density of 7.89 g/cm³, or a relative density of 94.2%, a carbon content of less than 0.01 wt %, a saturated induction Bₛ of 2.17 T (Tesla), a coercive force H_{c} of 89 A/m, a maximum permeability μₘₐₓ of 6790. The density and magnetic properties of the Fe-50Co soft magnetic metallic material fabricated in Embodiment I are superior to these of the products fabricated with the MIM process of MPIF Standard 35. Besides, the process of Embodiment I costs less.

### Comparison I

Comparison I is different from Embodiment I in that Comparison I does not use the spray drying process to fabricate the spray-dried powder but directly adds the Acrawax® lubricant to the Fe-50Co mixed powder. As the Fe-50Co mixed powder has poor flowability, the lubricant Acrawax® is added to the Fe-50Co mixture powder by a higher proportion (0.6 wt %). Despite the fact that a higher proportion of the lubricant is used, yet the flowability and apparent density of the Fe-50Co mixed powder cannot be measured. Next, feed the Fe-50Co mixture powder into a mold cavity manually. Next, compact the Fe-50Co mixed powder under a pressure of 300-1000 MPa. However, the green compact is hard to form and likely to crack into pieces.

It is learned from the above description: the Fe-50Co mixed powder has poor compressibility and poor compactability and cannot be fabricated into a green compact successfully as shown in Comparison I. Contrarily, in Embodiment I, the Fe-50Co mixture powder can be fabricated into a green compact, and the green compact can be sintered into a soft magnetic metallic material having high relative density and superior magnetic performance.

### Embodiment II

In Embodiment II, the initial powder is an Fe-49Co-2V pre-alloyed powder having a median particle diameter of 12 μm; the Fe-49Co-2V pre-alloyed powder includes 49 wt % of cobalt and 2 wt % of vanadium with the balance being iron. A binding agent used in Embodiment I is added to the Fe-49Co-2V pre-alloyed powder. A spray drying process used in embodiment I is used to fabricate the Fe-49Co-2V pre-alloyed powder into a spray-dried powder, whose particles are spherical with a median diameter of 78 μm. No lubricant is added to the spray-dried powder. The lubricant-free spray-dried powder is compacted under a pressure of 800 MPa at a temperature of 25° C. to form a green compact having a density of 6.4 g/cm³. Next, the green compact is placed in an atmosphere furnace filled with hydrogen, maintained at a temperature of 550° C. for 2 hours to remove the binding agent, and sintered at a temperature of 1340° C. for 1.5 hours to obtain an Fe-49Co-2V soft magnetic metallic material having a density of 7.81 g/cm³, a relative density of 94%, a saturated induction Bₛ of 1.85 T, a coercive force H_{c} of 320 A/m, a maximum permeability μₘₐₓ of 1740, and a carbon content of less than 0.01 wt %.

### Comparison II

Comparison II is different from Embodiment II in that Comparison II directly adds 0.5 wt % of the lubricant (Acrawax®) to the Fe-49Co-2V pre-alloyed powder. Despite the fact that a high proportion of the lubricant is added to the Fe-49Co-2V pre-alloyed powder, yet the flowability and apparent density of the Fe-49Co-2V pre-alloyed powder cannot be measured. Pressures varying from 300 to 1000 MPa are used to compact the Fe-49Co-2V pre-alloyed powder. However, the green compact is hard to form no matter what pressure is used.

It is learned from the above description: the Fe-49Co-2V pre-alloyed powder has poor compressibility and poor compactability and cannot be fabricated into a green compact successfully as shown in Comparison II. Contrarily, in Embodiment II, the Fe-49Co-2V pre-alloyed powder can be fabricated successfully into a green compact, and the green compact can be sintered into a soft magnetic metallic material having high relative density and superior magnetic performance.

### Embodiment III

In Embodiment III, the initial powder is a Fe-0.45 P mixed powder. In detail, the Fe-0.45P mixed powder is a mixture of iron phosphide (Fe₃P) powder and a carbonyl iron powder. The iron phosphide powder is a compound powder including 15.6 wt % of phosphorus with the balance being iron. The carbonyl iron powder is an elemental powder including 0.7 wt % of carbon. Both the iron phosphide powder and the carbonyl iron powder have a median particle diameter of less than 10 μm. The mixture of the iron phosphide powder and the carbonyl iron powder includes 0.45 wt % of phosphorus. The same binding agent and spray drying process as used in Embodiment I are used to fabricate spray-dried powder, whose particles are spherical with a median diameter of 65 μm. Next, the spray-dried powder is mixed with 0.3 wt % of Acrawax® and placed in a mold. Next, the spray-dried powder is compacted under a pressure of 700 MPa at a temperature of 60° C. to form a green compact having a density of 6.54 g/cm³. Next, the green compact is placed in an atmosphere furnace filled with 10 vol % of hydrogen and 90 vol % of nitrogen, maintained at a temperature of 550° C. for 2 hours to remove the binding agent and the lubricant, and sintered at a temperature of 1340° C. for 1.5 hours to obtain an Fe-0.45P soft magnetic metallic material having a density of 7.80 g/cm³, or a relative density of 99%, a saturated induction Bₛ of 1.75 T, a coercive force of H_{c} 40 A/m, a maximum permeability μₘₐₓ of 12400, and a carbon content of less than 0.01 wt %.

### Comparison III

Comparison III is different from Embodiment III in that Comparison III does not use the spray drying process to fabricate a spray-dried powder but adopts an Fe-0.45P mixed powder. The Fe-0.45P mixed powder is a mixture of a water-atomized iron powder and an iron phosphide (Fe₃P) powder and includes 0.45 wt % of phosphorus. The water-atomized iron powder includes less than 0.05 wt % of carbon and having a median particle diameter of 80 μm. The iron phosphide powder has a median particle diameter of 5 μm. The Fe-0.45P mixed powder has good flowability and is suitable for the conventional press-and-sinter process. Firstly, the Fe-0.45P mixed powder is mixed with 0.75 wt % of Acrawax® and placed in a mold. Next, the Fe-0.45P mixed powder is maintained at a temperature of 25° C. and compacted under a pressure of 600 MPa to form a green compact having a density of 6.9 g/cm³. Next, the green compact is placed in an atmosphere furnace filled with 75 vol % of hydrogen and 25 vol % of nitrogen, and sintered at a temperature of 1120° C. (the temperature most frequently used in the conventional press-and-sinter process) for 1 hour to obtain an Fe-0.45P soft magnetic metallic material having a density of 7.12 g/cm³, a relative density of 90.4%, a saturated induction Bₛ of 1.25 T, a coercive force H_{c} of 125 A/m, a maximum permeability μₘₐₓ of 3400, and a carbon content of less than 0.01 wt %. It is learned from the above description: the Fe-0.45P soft magnetic metallic material fabricated with the conventional material in the conventional press-and-sinter process in Comparison III is inferior to the Fe-0.45P soft magnetic metallic material fabricated in Embodiment III, in the relative density, the saturated induction, the coercive force and the maximum permeability.

### Embodiment IV

In Embodiment IV, the initial powder is a Fe-3Si mixed powder. In detail, the Fe-3Si mixed powder is a mixture of an Fe—Si master alloy powder and a carbonyl iron powder. The Fe—Si master alloy powder includes 7 wt % of silicon with the balance being iron. The carbonyl iron powder is an elemental powder including less than 0.05 wt % of carbon so as to increase the compressibility and the green compact density. The carbonyl iron powder has a median particle diameter of 5.3 μm. The Fe—3Si mixed powder includes 3 wt % of silicon with the balance being iron. Before the spray drying process, the Fe-3Si mixed powder is mixed with water and a binding agent uniformly. The binding agent includes polyvinyl alcohol and polyethylene glycol, and the total additive amount thereof is 0.7 wt %. The spray drying process fabricates the Fe-3Si mixture powder into a spray-dried powder with a spherical shape and with a median diameter of 56 μm. Next, the spray-dried powder is placed in a mold, maintained at a temperature of 120° C., and compacted under a pressure of 400 MPa to form a green compact having a density of 6.35 g/cm³. Next, the green compact is placed in an atmosphere furnace filled with cracked ammonia, maintained at a temperature of 550° C. for 2 hours to remove the binding agent, and then sintered at a temperature of 1320° C. for 2 hours to obtain an Fe-3Si soft magnetic metallic material having a density of 7.55 g/cm³, or a relative density of 98.5%, a saturated induction Bₛ of 1.9 T, a coercive force H_{c} of 70 A/m, a maximum permeability μₘₐₓ of 7100, and a carbon content of less than 0.03 wt %.

### Comparison IV

Comparison IV is different from Embodiment IV in that Comparison IV adopts a Fe-3Si mixed powder available for the commercial press-and-sinter process. In detail, the Fe-3Si mixed powder is a mixture of water-atomized iron powder and a Fe—Si master alloy powder. The Fe-3Si mixed powder includes 3 wt % of silicon with the balance being iron. The Fe-3Si mixture powder has a median particle diameter of 75 μm. Firstly, the Fe-3Si mixture powder is mixed with 0.8 wt % of Acrawax® and placed in a mold. Next, the Fe-3Si mixed powder is compacted under a pressure of 700 MPa at a temperature of 25° C. to form a green compact having a density of 6.8 g/cm³. Next, the green compact is placed in an atmosphere furnace filled with 75 vol % of hydrogen and 25 vol % of nitrogen, maintained at a temperature of 550° C. for 2 hours to remove the lubricant, and then sintered at a temperature of 1320° C. for 2 hours to obtain a Fe-3Si soft magnetic metallic material having a density of 7.0 g/cm³ or a relative density of 91.3%, a saturated induction Bₛ of 1.2 T, a coercive force H_{c} of 95 A/m, a maximum permeability μₘₐₓ of 4000, and a carbon content of less than 0.03 wt %.

It is learned from the above description: the Fe-3Si soft magnetic metallic material fabricated in the conventional press-and-sinter process in Comparison IV is inferior to the Fe-3Si fabricated in Embodiment VI, in the relative density, saturated induction, coercive force and maximum permeability.

### Embodiment V

In Embodiment V, the initial powder is a Fe-0.8P mixed powder. In detail, the Fe-0.8P mixture powder is a mixture of an iron phosphide (Fe₃P) powder and a carbonyl iron powder. The carbonyl iron powder includes less than 0.05 wt % of carbon. The Fe-0.8P mixture powder includes 0.8 wt % of phosphorus. Firstly, the Fe-0.8P mixed powder is mixed with water and a binding agent uniformly. The binding agent includes polyvinyl alcohol and polyethylene glycol, and the total additive amount thereof is 0.7 wt %. Next, the spray drying process fabricates the Fe-0.8P mixed powder into a spray-dried powder. Next, the spray-dried powder is mixed with 0.2 wt % of a lubricant (stearic acid) and placed in a mold. Next, the Fe-0.8P mixed powder is compacted under a pressure of 800 MPa at a temperature of 95° C. to form a green compact having a density of 6.55 g/cm³. Next, the green compact is placed in a vacuum furnace, maintained at a temperature of 550° C. for 2 hours to remove the binding agent and the lubricant, and then sintered at a temperature of 1300° C. for 1.5 hours to obtain an Fe-0.8P soft magnetic metallic material having a density of 7.80 g/cm³, a relative density of 99%, a saturated induction Bₛ of 1.65 T, a coercive force H_{c} of 53A/m, a maximum permeability μₘₐₓ of 11600, and a carbon content of less than 0.01 wt %.

### Comparison V

Comparison V adopts an initial powder the same as Embodiment V. However, Comparison V adopts the MIM process to fabricate the soft magnetic metallic material. Firstly, the mixture of the iron phosphide powder and the carbonyl iron powder is mixed with 8 wt % of a binding agent. The binding agent is a mixture of paraffin, stearic acid and polyethylene and includes about 3.0 wt % of polyethylene. Next, the MIM process is used to fabricate a green compact having a density of 5.1 g/cm³. The green compact is placed in the n-heptane solvent to remove paraffin and stearic acid. Next, the green compact is placed in a vacuum furnace, maintained at a temperature of 300-550° C. to remove the residual binding agent, and then sintered at a temperature of 1300° C. for 1.5 hours to obtain an Fe-0.8P soft magnetic metallic material having a density of 7.80 g/cm³ or a relative density of 99%, a saturated induction Bₛ of 1.55 T, a coercive force H_{c} of 45 A/m, a maximum permeability μₘₐₓ of 11000, and a carbon content of less than 0.03 wt %.

It is learned from the above description: the properties of the Fe-0.8P soft magnetic metallic material of Comparison V approximate the properties of the Fe-0.8P soft magnetic metallic material of Embodiment V. However, Embodiment V uses only 1.0 wt % of the binding agent and lubricant, which is much less than 8 wt % of the binding agent and lubricant used in Comparison V. Embodiment V not only has a lower material cost but also does not need to use an additional debinding process. Therefore, Embodiment V has a lower fabrication cost and does not need to deal with the environmental-protection problem of waste solvents. In Comparison V, the MIM process uses about 3 wt % of polyethylene and spends much time in heating and burning out the polyethylene. The mold used by the MIM process is much more expensive than the mold used by the ordinary pres-and-sinter process. Estimated totally, the cost of Embodiment V is 35% cheaper than that of Comparison V.

Further, the proportion of the binding agent plus the lubricant is only 1.0 wt %, and the green compact density is as high as 6.55 g/cm³, in Embodiment V. In other words, the proportion of the metal powder is 82.5 vol % in Embodiment V. Contrarily, the proportion of the binding agent is 8.0 wt %, and the green compact density is 5.1 g/cm³, in Comparison V. The proportion of the metal powder is only 59.7 vol % in Comparison V. In Embodiment V, the linear shrinkage is only 5.9% while the density of the sintered Fe-0.8P soft magnetic metallic material has reached 99 vol %. However, the sintered Fe-0.8P soft magnetic metallic material has a linear shrinkage as high as 15.5% in Comparison V. Therefore, the technology of Comparison results in poor dimensional stability.

### Embodiment VI

In Embodiment VI, the initial powder is a Fe-50Ni mixed powder. In detail, the Fe-50Ni mixture powder is a mixture of a carbonyl iron powder and a carbonyl nickel powder. The Fe-50Ni mixed powder includes 50 wt % of nickel with the balance being iron. Each of the carbonyl iron powder and the carbonyl nickel powder includes less than 0.05 wt % of carbon and has a median particle diameter of less than 10 μm. In Embodiment VI, the spray drying process and the binding agent used in Embodiment V are also used to fabricate the Fe-50Ni mixed powder into a spray-dried powder, which is measured to have a flowability of 31 sec/50 g and an apparent density of 2.2 g/cm³, and whose particles are formed to a near-spheroidal shape with a median diameter of 74 μm. Next, the spray-dried powder is placed in a mold, maintained at a temperature of 55° C., and compacted under a pressure of 500 MPa to form a green compact having a density of 6.5 g/cm³. Next, the green compact is placed in a vacuum furnace filled with a small amount of argon having a partial pressure of 0.05 atm, maintained at a temperature of 300-600° C. to remove the binding agent, and then sintered at a temperature of 1350° C. for 2 hours to obtain an Fe-50Ni soft magnetic metallic material having a density of 7.95 g/cm³, a relative density of 95%, a saturated induction Bₛ of 1.45 T, a coercive force H_{c} of 16 A/m, a maximum permeability μₘₐₓ of 27000, and a carbon content of less than 0.01 wt %. The magnetic performance of the soft magnetic metallic material fabricated in Embodiment VI parallels that of the soft magnetic metallic material fabricated with the MIM process of MPIF Standard 35. However, the fabrication cost of Embodiment VI is less than that of the MIM process.

### Comparison VI

Comparison VI is different from Embodiment VI in that Comparison VI directly mixes the Fe-50Ni mixed powder with the lubricant (Acrawax®). However, the flowability and apparent density of the lubricant-modified Fe-50Ni mixture powder of Comparison VI is unmeasurable. Next, the Fe-50Ni mixed powder is fed into a mold cavity manually and compacted under pressures varying from 300 to 1000 MPa. However, the green compact is hard to form successfully but likely to crack into pieces, no matter what a pressure is used.

It is learned from the above description: the Fe-50Ni mixed powder has poor compressibility and poor compactability in Comparison VI. Even though the pressure is increased to 1000 MPa, the Fe-50Ni mixed powder cannot yet be fabricated into a successful green compact in Comparison VI. Contrarily, in Embodiment VI, the Fe-50Ni mixed powder can be fabricated into a successful green compact, and the green compact can be sintered into a soft magnetic metallic material having high relative density and superior magnetic performance.

### Embodiment VII

In Embodiment VII, the initial powder is an Fe-79Ni-4Mo mixed powder. In detail, the Fe-79Ni-4Mo mixed powder is a mixture of a carbonyl iron powder, a carbonyl nickel powder and a molybdenum powder. The Fe-79Ni-4Mo mixture powder includes 79 wt % of nickel and 4 wt % of molybdenum with the balance being iron. The carbonyl iron includes 0.8 wt % of carbon. Each of the carbonyl nickel powder and the molybdenum powder includes less than 0.05 wt % of carbon. All powders have a median particle size of less than 10 μm. In Embodiment VII, the spray drying process and the binding agent used in Embodiment V are also used to fabricate the Fe-79Ni-4Mo mixed powder into a spray-dried powder, which is measured to have a flowability of 32 sec/50 g and an apparent density of 2.3 g/cm³, with a spherical shape and a median diameter of 72 μm. Next, the spray-dried powder is mixed with 0.2 wt % of lubricant (Acrawax®), placed in a mold, maintained at a temperature of 27° C., and then compacted under a pressure of 500 MPa to form a green compact having a density of 6.3 g/cm³. Next, the green compact is placed in an atmosphere furnace filled with hydrogen, maintained at a temperature of 300-600° C. to remove the binding agent and the lubricant, and then sintered at a temperature of 1350° C. for 2 hours to obtain an Fe-79Ni-4Mo soft magnetic metallic material having a density of 8.3 g/cm³, a relative density of 95%, a saturated induction Bₛ of 0.8 T, a coercive force H_{c} of 89 A/m, a maximum permeability μₘₐₓ of 120000, and a carbon content of less than 0.01 wt %.

### Comparison VII

Comparison VII adopts an initial powder the same as Embodiment VII but uses the MIM process, which is different from that used by Embodiment VII. Firstly, the Fe-79Ni-4Mo mixed powder is mixed with a binding agent, which is a mixture of paraffin, stearic acid and polyethylene. The total additive amount of the binding agent is 8.0 wt %, and the polyethylene is about 3.0 wt %. Next, the MIM process is used to fabricate the Fe-79Ni-4Mo mixed powder into a green compact having a density of 5.3 g/cm³. Next, the green compact is placed in the n-heptane solvent to remove paraffin and stearic acid. Next, the green compact is placed in an atmosphere furnace filled with hydrogen, maintained at a temperature of 300-600° C. to remove the residual binding agent, and then sintered at a temperature of 1350° C. for 2 hours to obtain an Fe-79Ni-4Mo soft magnetic metallic material having a density of 8.25 g/cm³ or a relative density of 94%, a saturated induction Bₛ of 0.8 T, a coercive force H_{c} of 95 A/m, and a maximum permeability μₘₐₓ of 115000.

It is learned from the above description: the properties of the Fe-79Ni-4Mo soft magnetic metallic material of Comparison VII approximate the properties of the Fe-79Ni-4Mo soft magnetic metallic material of Embodiment VII. However, Embodiment VII uses less binding agent and lubricant than Comparison VII. Embodiment VII not only has a lower material cost but also does not need to use an additional debinding process. Therefore, Embodiment VII has a lower fabrication cost and does not need to deal with the environmental-protection problem of waste solvents. Embodiment VII adopts the ordinary press-and-sinter process, and Comparison VII adopts the MIM process. The mold used by the MIM process is much more expensive than the mold used by the ordinary press-and-sinter process. Estimated total cost of Embodiment VII is 35% cheaper than that of Comparison VII.

As the green compact density of Embodiment VII (6.3 g/cm³) is obviously greater than the green compact density of Comparison VII (5.3 g/cm³), the linear shrinkage of the sintered Fe-79Ni-4Mo soft magnetic metallic material of Embodiment VII is lower than the linear shrinkage of the sintered Fe-79Ni-4Mo soft magnetic metallic material of Comparison VII. Therefore, Embodiment VII has better dimensional stability and higher yield.

In conclusion, the present invention is characterized in
1. The present invention uses the spray drying process to convert fine powders into coarse spherical spray-dried powder. The spray-dried powder has superior flowability, compactability and compressibility. Hence, the present invention can overcome the problems of fabricating fine powder into green compacts using the conventional press-and-sinter process due to the poor flowability, compactability and compressibility of fine powders.
2. Owing to the abovementioned factors and the factor that the present invention uses an initial powder having a median particle diameter smaller than 15 μm, the sintered soft magnetic metallic material fabricated by the present invention outperforms that fabricated by the conventional pres-and-sinter process, in relative density and magnetic performance.
3. As the present invention uses the spray drying process to obtain a spray-dried powder having a spherical shape and having superior flowability, compactability and compressibility, the conventional press-and-sinter process can directly fabricate the spray-dried powder into green compacts. Hence, the present invention can overcome the problems of high price, poor dimensional stability and low yield of the sintered soft magnetic metallic materials fabricated by the conventional MIM process.

What is claimed is:

1. A powder metallurgical method for fabricating a high-density soft magnetic metallic material, comprising
Step S1: providing an initial powder including iron and featuring soft magnetism, wherein the initial powder has a median particle diameter of 1-15 μm, wherein the iron is sourced from a carbonyl iron powder;
Step S2: using a spray drying process to fabricate the initial powder into a spray-dried powder, wherein the spray-dried powder has a spherical shape or a near-spheroidal shape with a median diameter of 40-100 μm;
Step S3: placing the spray-dried powder in a mold, maintaining the spray-dried powder at a temperature of 20-150° C., and compacting the spray-dried powder under a pressure of 300-1000 MPa to form a green compact; and
Step S4: sintering the green compact at a temperature of 1100-1400° C. in a protection atmosphere to form a soft magnetic metallic material.

2. The powder metallurgical method for fabricating a high-density soft magnetic metallic material according to claim 1, wherein the initial powder includes iron and at least one additive element selected from a group consisting of phosphorus, silicon, cobalt, vanadium, nickel, molybdenum, and combinations thereof.

3. The powder metallurgical method for fabricating a high-density soft magnetic metallic material according to claim 1, wherein the initial powder is selected from a group consisting of elemental powders, compound powders, and master alloy powders.

4. The powder metallurgical method for fabricating a high-density soft magnetic metallic material according to claim 1, wherein the protection atmosphere in the Step S4 is vacuum, argon, nitrogen, or a reducing atmosphere containing hydrogen.

5. The powder metallurgical method for fabricating a high-density soft magnetic metallic material according to claim 2, wherein the initial powder includes 0.4-0.9 wt % of phosphorus with the balance being iron and unavoidable impurities.

6. The powder metallurgical method for fabricating a high-density soft magnetic metallic material according to claim 2, wherein the initial powder includes 2-6 wt % of silicon with the balance being iron and unavoidable impurities.

7. The powder metallurgical method for fabricating a high-density soft magnetic metallic material according to claim 2, wherein the initial powder includes 48-52 wt % of cobalt and less than 3 wt % of vanadium with the balance being iron and unavoidable impurities.

8. The powder metallurgical method for fabricating a high-density soft magnetic metallic material according to claim 2, wherein the initial powder includes 48-52 wt % of nickel with the balance being iron and unavoidable impurities.

9. The powder metallurgical method for fabricating a high-density soft magnetic metallic material according to claim 2, wherein the initial powder includes 77-83 wt % of nickel and less than 5 wt % of molybdenum with the balance being iron and unavoidable impurities.

10. The powder-metallurgical method for fabricating a high-density soft magnetic metallic material according to claim 1, wherein the carbonyl iron powder includes less than 0.05 wt % of carbon.

11. A method for fabricating a soft magnetic metallic material, comprising
Step S1: providing an initial powder including iron and featuring soft magnetism, wherein the initial powder is a pre-alloyed powder and has a median particle diameter of 1-15 μm;
Step S2: using a spray drying process to fabricate the initial powder into a spray-dried powder, wherein the spray-dried powder has a spherical shape or a near-spheroidal shape with a median diameter of 40-100 μm;
Step S3: placing the spray-dried powder in a mold, maintaining the spray-dried powder at a temperature of 20-150° C., and compacting the spray-dried powder under a pressure of 300-1000 MPa to form a green compact; and
Step S4: sintering the green compact at a temperature of 1100-1400° C. in a protection atmosphere to form a soft magnetic metallic material.

12. The method for fabricating a soft magnetic metallic material according to claim 11, wherein the initial powder includes iron and at least one additive element selected from a group consisting of phosphorus, silicon, cobalt, vanadium, nickel, molybdenum, and combinations thereof.

13. The method for fabricating a soft magnetic metallic material according to claim 11, wherein the protection atmosphere in the Step S4 is vacuum, argon, nitrogen, or a reducing atmosphere containing hydrogen.

14. The method for fabricating a soft magnetic metallic material according to claim 12, wherein the initial powder includes 0. 4-0.9 wt % of phosphorus with the balance being iron and unavoidable impurities.

15. The method for fabricating a soft magnetic metallic material according to claim 12, wherein the initial powder includes 2-6 wt % of silicon with the balance being iron and unavoidable impurities.

16. The method for fabricating a soft magnetic metallic material according to claim 12, wherein the initial powder includes 48-52 wt % of cobalt and less than 3 wt % of vanadium with the balance being iron and unavoidable impurities.

17. The method for fabricating a soft magnetic metallic material according to claim 12, wherein the initial powder includes 48-52 wt % of nickel with the balance being iron and unavoidable impurities.

18. The method for fabricating a soft magnetic metallic material according to claim 12, wherein the initial powder includes 77-83 wt % of nickel and less than 5 wt % of molybdenum with the balance being iron and unavoidable impurities.
